(19) United States
(12) Patent Application Publication
(10) Pub. No.: US 2026/0256118 A1
(43) Pub. Date: Sep. 3, 2026

(54) HEALTH MONITORING SYSTEM FOR ANIMALS AND LIVING SPACE

(71) Applicant: Nimble Wireless Inc., Oakland, CA (US)

(72) Inventors: Marimuthu Sivakumar, Parker, TX (US); Ramasubramaniyam Esakky, Coimbatore (IN); Sridhar Sundarraj, Coimbatore (IN)

(21) Appl. No.: 19/068,050

(22) Filed: Mar. 3, 2025

(51) Int. Cl. A01K 29/00

(52) U.S. Cl. CPC A01K 29/005

(57) ABSTRACT

A health monitoring system for monitoring health promoting conditions of a living space and health indications of an animal present in the living space in real time. The health monitoring system comprises a central control unit adapted for placement in the living space to regularly measure and record data indicative of the health promoting conditions in the living space. The central control unit receives sensor data transmitted by a sensing device selected from the group consisting of a living space sensor spaced from the central control unit for sensing a health promoting condition of the living space and an animal sensor positioned for measuring the health indication of the animal. The central control unit further stores the sensor data and alerts the user of aberrant condition if conditions in the living space are outside a limit.

### BACKGROUND

The present disclosure is directed to a health monitoring system and more particularly to a system for monitoring health promoting conditions of a living space and health indications of an animal inhabiting the living space.

Pet owners want their animals to be safe when the owners are at home or away. Safety is also important when the animals are in a permanent building such as a house or apartment, and when they are in mobile spaces, such as movable recreational vehicles, travel trailers, and campers. These mobile habitats are particularly problematic because the conditions inside the vehicle can vary depending on the weather, whether reliable power is available, and conditions at the campsite. Further, pet owners often wish to leave their pet in the recreational vehicle while they sightsee or participate in other activities without their pet. But leaving a pet unattended in a recreational vehicle puts the pet at risk. For example, if a recreational vehicle loses power in a hot climate, the temperature in the recreational vehicle can increase to levels that may harm the pet. Conversely, if a recreational vehicle loses power in a cold climate, the temperature in the recreational vehicle can fall to levels that may harm the pet. Other problems like water leaks, excessive humidity levels, excessive heat indices, poor air quality, and doors not being closed can also cause problems. Knowing the conditions inside the vehicle is essential to ensuring a safe and healthy environment for pets left in the vehicle. But without a way to automatically and regularly monitor the environmental conditions in the recreational vehicle, pet owners must return to the recreational vehicle periodically to check on their pet. This can limit the pet owner's ability to enjoy time spent away and limit how long they can be away.

In view of the drawbacks discussed above, there remains a need for a health monitoring system that (i) allows remote pet monitoring in real time, (ii) alerts a user automatically in real time if conditions in a living space become unhealthful for the pet or varies from desirable norms, and (iii) permits alert parameters to be controlled remotely in real time.

### SUMMARY

In one aspect, the present disclosure includes a health monitoring system for monitoring health promoting conditions of a living space and health indications of an animal present in the living space. The health monitoring system also assesses the health promoting conditions to characterize healthfulness of the living space and the health indications to characterize health of the animal. The health monitoring system further communicates the healthfulness and the health to a user in real time. The health monitoring system comprises a central control unit adapted for placement in the living space to regularly measure and record data indicative of the health promoting conditions in the living space. The data include (i) temperature in the living space, (ii) humidity in the living space, and (iii) electrical power supplied to the living space. The central control unit is further adapted to receive sensor data transmitted by a sensing device selected from the group consisting of a living space sensor spaced from the central control unit for sensing a health promoting condition of the living space and an animal sensor positioned for measuring the health indication of the animal. The central control unit is adapted to store the sensor data. The central control unit is further adapted to alert the user of an aberrant temperature condition if the temperature in the living space is outside a temperature limit. The central control unit is further adapted to alert the user of an aberrant humidity condition if the humidity in the living space is outside a humidity limit. The central control unit is further adapted to alert the user of an electrical status change condition if the electrical power supplied to the living space changes by an amount exceeding a preselected power change limit.

In another aspect, the present disclosure includes a health monitoring system for monitoring health promoting conditions of a living space and health indications of an animal present in the living space. The health monitoring system also assesses the health promoting conditions to characterize healthfulness of the living space and the health indications to characterize health of the animal. The health monitoring system also communicates the healthfulness and the health to a user in real time. The health monitoring system comprises a central control unit adapted for placement in the living space to regularly measure and record data indicative of the health promoting conditions in the living space. The data includes (i) temperature in the living space and (iii) electrical power supplied to the living space. The central control unit is further adapted to receive sensor data transmitted by a sensing device selected from the group consisting of a living space sensor spaced from the central control unit for sensing a health promoting condition of the living space and an animal sensor positioned for measuring the health indication of the animal. The central control unit is further adapted to store the sensor data. The central control unit is further adapted to alert the user of an aberrant temperature condition if the temperature in the living space is outside a temperature limit by transmitting a signal to a mobile device. The central control unit is further adapted to alert the user of an electrical status change condition if the electrical power supplied to the living space changes by an amount exceeding a preselected power change limit by transmitting a signal to a mobile device.

In still another aspect, the present disclosure includes a method for using a central control unit adapted for placement in a living space for monitoring health promoting conditions of a living space and health indications of an animal present in the living space, assessing the health promoting conditions to characterize healthfulness of the living space and the health indications to characterize health of the animal, and communicating the healthfulness and the health to a user in real time. The method comprises measuring and recording data with the central control unit in the living space. The data is indicative of the health promoting conditions in the living space, including (i) temperature in the living space, (ii) humidity in the living space, and (iii) electrical power supplied to the living space. The method further comprises receiving sensor data with the central control unit transmitted by a sensing device selected from the group consisting of a living space sensor spaced from the central control unit for sensing a health promoting condition of the living space and an animal sensor positioned for measuring the health indication of the animal. The method further comprises storing the sensor data. The method further comprises alerting the user of an aberrant temperature condition if the temperature in the living space is outside a temperature limit. The method further comprises alerting the user of an aberrant humidity condition if the humidity in the living space is outside a humidity limit. The method further comprises alerting the user of an electrical status change condition if the electrical power supplied to the living space changes by an amount exceeding a preselected power change limit.

Other aspects of the present disclosure will be apparent in view of the following description and claims.

### BRIEF DESCRIPTION OF DRAWINGS

The present disclosure includes non-limiting examples illustrated in the accompanying drawings.

FIG. 1 is a schematic of an example of a health monitoring system within a living space; and

FIG. 2 is a flowchart of an exemplary method for using a central control unit of a health monitoring system.

Corresponding reference characters indicate corresponding parts throughout the drawings.

### DETAILED DESCRIPTION

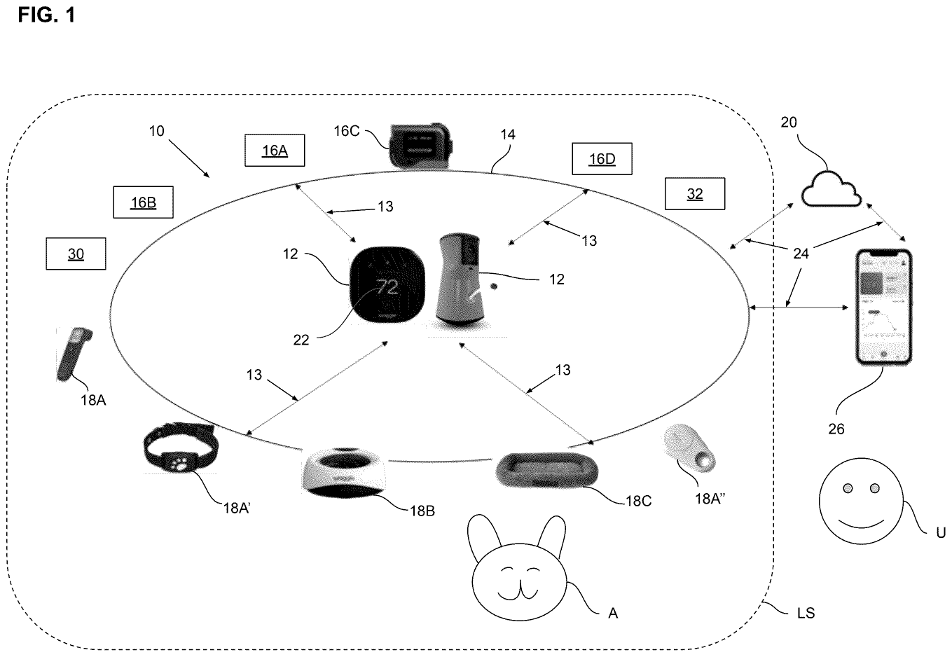

As shown in FIG. 1, one example of a health monitoring system of the present disclosure is designated in its entirety by the reference number 10. The system 10 monitors health promoting conditions in a defining habitat or living space LS and health indications of an animal A located in the living space. The health monitoring system 10 assesses the health promoting conditions to characterize healthfulness of the living space LS and the health indications to characterize health of the animal A. The health monitoring system 10 communicates the conditions and indications, as well as the healthfulness characterization and the health characterization to a user U such as a pet owner in real time, who need not be present in the living space LS. Communicating the conditions and indications to a remote user U in real time provides valuable information to the user about the health and welfare of animals A in the living space while the user is away. In this manner, the health monitoring system 10 provides the user U with valuable information and peace of mind regarding the conditions in living space LS and whether those conditions safely support the health of the animal A inside. As used herein, the phrase “in real time” means contemporaneous or simultaneous with the sensing or creation of the data provided to the user U. The health monitoring system 10 may be used in permanent or temporary living spaces, including homes, apartments, vacation cabins, boats, campers, travel trailers, and recreational vehicles to name a few.

As further shown in FIG. 1, the health monitoring system 10 comprises a central control unit 12 adapted for placement within the living space LS to regularly measure and record data indicative of the health promoting conditions in the living space. Data indicative of health promoting conditions in the living space LS include (i) temperature in the living space, (ii) humidity in the living space, and (iii) electrical power supplied to the living space, although tracking alternative or additional health promoting conditions is also contemplated as being within the scope of the present example. Although two examples of central control units 12 are depicted in FIG. 1, only one central control unit need be present in the health monitoring system 10 for the system to perform.

The central control unit 12 is further adapted to receive sensor data transmitted by a sensing device, generally indicated 14. Any number of sensing devices 14 may be utilized. In FIG. 1, an array of possible sensing devices 14 is indicated by the ring of connectivity depicted around the central control unit 12. The sensing device 14 is adapted to sense data from various locations within and around the living space LS. In one example, the sensing device 14 can be (i) a living space or habitat sensor 16 spaced from the central control unit for sensing a health promoting condition in the living space LS and/or (ii) an animal sensor 18 positioned for measuring the health indication of the animal A. Other sensing devices 14 are also contemplated as within the scope of the present example.

In one example, the health monitoring system 10 comprises one or more sensing devices 14 of the following types: a living space door position sensor 16A, a living space water level sensor 16B, a living space water leak sensor 16C, a living space slope sensor 16D, an animal diagnostic characteristic sensor 18A, and an animal smart bowl 18B. Each of these sensing devices 14 provides additional information to the user U to determine whether the living space LS appropriately supports the animal A. Moreover, the health monitoring system 10 is adapted to integrate other sensing devices 14 present in the living space LS, collecting data from each of the sensing devices and providing that data to the user via the central control unit 12. And because the central control unit 12 can communicate with a remote or mobile device 26 via a wireless network, the user U can monitor and receive alerts regarding data collected from multiple sensing devices 14 when not present in the living space. The central control unit 12 and sensing devices 14 are adapted to connect to the cloud in multiple ways, including via Cellular networks, Wi-Fi networks, and satellite networks, ensuring dependable operation when in remote locations. The central control unit 12 is adapted to plug into an outlet in the living space LS, but optionally includes an internal battery for use when disconnected or power is otherwise unavailable. The sensing devices 14 are adapted to communicate with one another and with the central control unit 12, along with communicating with other devices, vehicles, appliances, and other objects via an Internet of Things (IoT) network, such as via Bluetooth, Wi-Fi, Thread, or other communication protocol and/or network. This connection with the IoT provides the central control unit 12 and sensing devices 14 with the ability to integrate with and communicate with other objects, vehicles, devices, and physical and virtual devices inside and outside the health monitoring system to further expand the interconnectivity of the overall health monitoring system.

The living space door position sensor 16A monitors whether a door to the living space LS is closed and alerts the user U when the door is open, allowing the user to know whether the door was closed after use. The living space door position sensor 16A also provides real-time alerts via the central control unit 12 when the door is opened by an unauthorized individual. The door position sensor 16A may also include a camera, providing images (e.g. color images, thermal images, night vision images, etc.) to the user U via the central control unit 12 and a wireless network, allowing users to remotely monitor who is approaching entry points to the living space LS. The living space water level sensor 16B detects the level of water in water tanks supplying the living space LS, allowing the user U to monitor tank levels remotely to ensure levels remain sufficient for current needs within the living space. The living space water leak sensor 16C is adapted to sense water pooling in the living space LS, such as from a plumbing system leak, providing the user U with valuable alerts and information about conditions in the living space. The living space water leak sensor 16C sends the user U an alert when there is a water leak so the user can arrange to turn the water off more quickly to reduce any damage to the living space LS interior. The living space slope sensor 16D is particularly useful with a recreational vehicle, travel trailer, or camper. The sensor 16D collects data about whether the recreational vehicle, travel trailer, or camper is level. A user U can use this data from the living space slope sensor 16D when setting up camp to ensure that the living space LS is level. It is envisioned that any of the sensing devices 14 can include a camera to provide images (e.g. color images, thermal images, night vision images, etc.) to enable real-time surveillance and activity-based alerts and video and image recording. For example, a thermal camera included in the sensing device 14 can provide information about body temperatures of animals A within the living space LS. Additional sensing devices 14 may be added to the health monitoring system 10 to provide data about other conditions in the living space LS. These sensing devices 14 include, but are not limited to, water flow sensors and valves for regulating flow of water through the plumbing system of the living space to aid in conservation and water temperature sensors to sense water temperature in the plumbing system of the living space to provide alerts if there is an imminent risk of freezing.

The animal smart bowl 18B measures one or more characteristics such as food consumption, calories consumed, food quantity, calories available, and presence of the animal A. The animal smart bowl 18B permits users U to input the quantity of food added to the bowl. Alternately, the animal smart bowl 18B includes a camera to detect food received in the bowl, whereby the bowl can determine the quantity and calories of food received in the bowl. Input from the camera may also be utilized by the animal smart bowl 18B in determining the calories consumed by the animal A during a period, such as over the course of a day. The animal smart bowl 18B provides such information to the user U about the eating habits of the animal A. A user U can use this information to ensure the animal A is eating appropriately when the user is absent from the living space LS.

In another example, the sensing device 14 includes an animal diagnostic characteristic sensor 18A mounted in an animal bed 18C to measure one or more characteristics such as animal weight, animal body temperature, animal heart rate, and animal respiration rate. In yet another example, the animal diagnostic characteristic sensor 18A measures one or more characteristics such as animal body temperature, animal heart rate, blood oxygen saturation of the animal A, blood pressure of the animal, animal movement, animal activity level, animal sleep duration, animal location, animal destructiveness, animal wellness, animal comfort, animal connectedness, and animal bondedness. The collection of data regarding animal health characteristics as discussed above can be used by a pet owner or veterinarian to diagnose the health status of the animal in real time and to detect health issues for timely intervention and improved health care.

In still another example, the animal diagnostic characteristic sensor 18A is adapted to be secured to the animal A, such as in a detachable collar 18A′, harness (not shown), or tag 18A″. The collar 18A′, harness (not shown), or tag 18A″ includes a GPS sensor to provide animal-specific GPS data to the user U. For example, the GPS data can be used to alert the user if the GPS sensor crosses a geofence. The GPS sensor within the collar 18A′, harness (not shown), or tag 18A″ permits users to track the location of their animal A. It is contemplated in this example that other sensing devices may be added to the health monitoring system 10 to provide data about other conditions of the animal A.

The central control unit 12 is further adapted to store the sensor data. The data can be stored in different places, including an internal memory inside the central control unit, remotely in the cloud 20, or in internal memory inside the mobile device 26. The central control unit 12 further comprises a user interface 22 that accesses and displays temperature data, humidity data, time, and sensor data. This data can be presently sensed data or stored historical data as discussed above. The user U can use the user interface 22 to access and display presently sensed data and/or stored data depending upon user input into the user interface. This capability allows the user U to revisit historical data to understand trends and patterns in the data for analysis. It is envisioned that the user interface 22 can be adapted to receive commands via buttons, touchscreens, and/or voice commands through a microphone. The central control unit 12 further comprises a speaker for auditory alerts or data dissemination to the user U.

The user interface 22 is adapted for setting a temperature limit and a humidity limit. In one example, the temperature limit comprises a low temperature limit and a high temperature limit, and the humidity limit comprises a low humidity limit and a high humidity limit. The central control unit 12 is also adapted to be pre-programmed with initial temperature limits deemed appropriate for most animals A and living spaces LS. For example, an initial high temperature limit of 80 degrees Fahrenheit and an initial low temperature limit of 60 degrees Fahrenheit establishes a temperature range for the living space LS that will accommodate most animals A. But if the user U deems these limits inappropriate, the user may utilize the user interface 22 to raise or lower the high and low temperature limits accordingly. For example, some reptiles and aquatic animals may require different temperature settings than cats and dogs. Similarly, the central control unit 12 is also adapted to be pre-programmed with initial humidity limits deemed appropriate for most animals A and living spaces LS. For example, an initial high humidity limit of 60 percent and an initial low temperature limit of 30 percent establishes a humidity range for the living space LS that will accommodate most animals A. But if the user U deems these limits inappropriate, the user may utilize the user interface 22 to raise or lower the high and low humidity limits accordingly. When other sensing devices 14 are used, the user interface 22 may be utilized to view and change limits and alert settings associated with those sensing devices.

The central control unit 12 is further adapted to alert the user U of aberrant conditions within the living space LS that may be of interest to the user. These aberrant conditions within the living space LS triggering alerts may be based upon data from any of the sensing devices 14. For example, the central control unit 12 is adapted to alert the user U of an aberrant temperature condition if the temperature in the living space LS is outside a temperature limit. More particularly, the central control unit 12 is adapted to alert the user U of a low temperature condition if the temperature in the living space LS is less than a low temperature limit and to alert the user of a high temperature condition if the temperature in the living space is greater than a high temperature limit. The central control unit 12 is further adapted to alert the user U of the low temperature condition using short message service (i.e., a text message) and/or email. Similarly, the central control unit 12 is further adapted to alert the user U of the high temperature condition using short message service and/or email.

In another example, the central control unit 12 is further adapted to alert the user U of the low temperature condition by transmitting a signal to a mobile device 26 or other computing device, such as a smart watch or computer. For example, the user U can install an application on a mobile device 26 (or other computing device) that is adapted to communicate directly with the central control unit 12 via the wireless network, such as a Cellular, Wi-Fi, or satellite network. The application can include other functionality, including monitoring and controlling the health monitoring system 10, the central control unit 12, and the sensing devices 14. Similarly, the central control unit 12 is further adapted to alert the user U of the high temperature condition by transmitting a signal to the mobile device 26 or other computing device, such as a smart watch or computer. Moreover, the central control unit 12 also functions as a Wi-Fi network hub, allowing computing devices and mobile devices to network with the central control unit to access the internet and cloud.

The central control unit 12 also alerts the user U of an aberrant humidity condition if the humidity in the living space LS is outside a humidity limit. More specifically, the central control unit 12 alerts the user U of a low humidity condition if the humidity in the living space LS is less than a low humidity limit and alerts the user U of a high humidity condition if the humidity in the living space is greater than a high humidity limit. The central control unit 12 alerts the user U of the low humidity condition or high humidity condition with a short message service and/or email. In another example, the central control unit 12 alerts the user U of the low humidity condition or high humidity condition by transmitting a signal to the mobile device 26. The user U can use the user interface 22 or the application to select how the central control unit 12 will alert the user, allowing for specific alerts types for different types of alerts.

Further, the central control unit 12 alerts the user U of an electrical status change condition from a power sensor 30 if the electrical power supplied to the living space LS changes by an amount exceeding a preselected power change limit. For example, if the power sensor 30 senses that the electrical power changes from on to off, the central control unit 12 alerts the user of the change in condition. Similarly, if the power sensor 30 senses that the electrical power changes from off to on, the central control unit 12 alerts the user of the change in condition. Also, if the power sensor senses that the electrical power changes from on to a level below a particular percentage of power (e.g., 50%), the central control unit 12 alerts the user of the reduction in power. Electrical power supplied to the living space LS may be supplied through a variety of sources, including shore power, grid power, or through a generator. Moreover, for a living space LS equipped with solar panels or other variable energy source, the power sensor 30 can provide data to the user U about current power generation from the solar panels or other variable energy source.

The central control unit 12 is further adapted to calculate heat index from the temperature and the humidity and alert the user U of a high heat index condition if the heat index is greater than a high heat index limit. The central control unit 12 is further adapted to measure and record at a preselected interval air quality index (AQI) data, total volatile organic compound (TVOC) data, and carbon dioxide data within the living space LS. These measurements focus on air quality within the living space LS, which is an important health characteristic impacting the animal A within the living space. Thus, the central control unit 12 is further adapted to alert the user U of a high AQI condition if the AQI data is greater than a high AQI limit, alert the user of a high TVOC condition if the TVOC data is greater than a high TVOC limit, and alert the user of a high carbon dioxide condition if the carbon dioxide data is greater than a high carbon dioxide limit. These alerts provide insights into the indoor air conditions, allowing users U to take necessary actions to maintain the health promoting conditions of the living space LS. In one example, the preselected interval the central control unit 12 is adapted to measure and record these air conditions is less than about ten minutes. In another example, the preselected internal is less than about five minutes. The preselected interval may be modified or adjusted by the user U via the user interface 22 or application. As discussed previously, the user U may utilize the application installed on the mobile device 26 (or other computing device) to monitor and control the health monitoring system 10, the central control unit 12, and the sensing devices 14, including adjusting the frequency of the preselected interval to measure and record data more or less frequently as required by the user.

The central control unit 12 is further adapted to receive global positioning system (GPS) data from a GPS sensor 32, provide the GPS data to the user U, and alert the user if the GPS sensor crosses a geofence. The GPS sensor 32 permits users to track the location of their living space LS, such as their recreational vehicle, during travel.

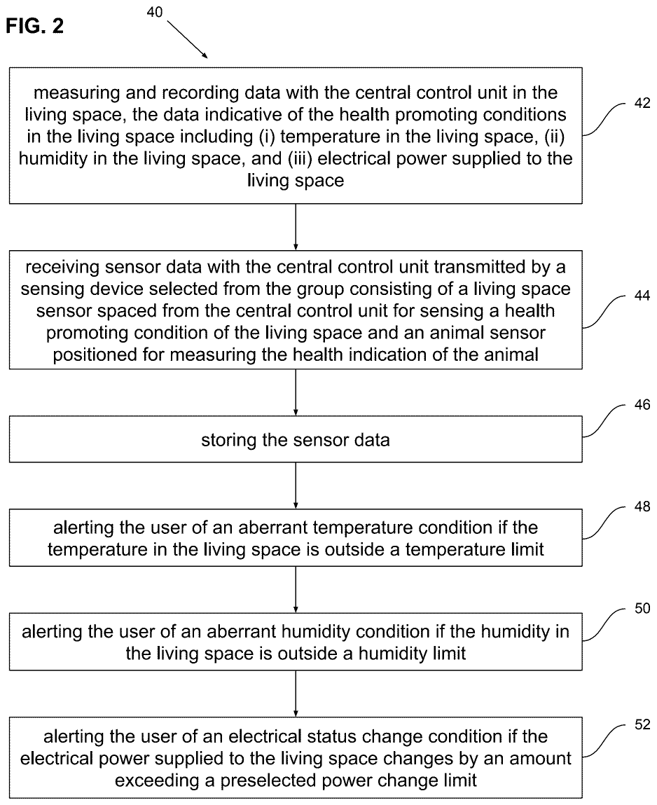

As shown in FIG. 2, one example of a method, designated in its entirety by reference number 40, for using a central control unit 12 adapted for placement in a living space LS for monitoring health promoting conditions of a living space and health indications of an animal A present in the living space and assessing the health promoting conditions to characterize healthfulness of the living space and the health indications to characterize health of the animal, and communicating the healthfulness and the health to a user U is shown. The method comprises measuring and recording data 42 with the central control unit 12 in the living space LS. The data are indicative of the health promoting conditions in the living space LS including (i) temperature in the living space, (ii) humidity in the living space, and (iii) electrical power supplied to the living space. The method further comprises receiving sensor data 44 with the central control unit 12 transmitted by a sensing device 14 selected from the group consisting of a living space sensor 16 spaced from the central control unit for sensing a health promoting condition of the living space LS and an animal sensor 18 positioned for measuring the health indication of the animal A. The method further comprises storing the sensor data 46. The method additionally alerts the user U of an aberrant temperature condition 48 if the temperature in the living space LS is outside a temperature limit, alerts the user of an aberrant humidity condition 50 if the humidity in the living space is outside a humidity limit, and alerts the user of an electrical status change condition 52 if the electrical power supplied to the living space changes by an amount exceeding a preselected power change limit.

When introducing elements in this description and the claims, the articles “a”, “an”, “the”, and “said” are intended to indicate one or more of the elements. The terms “comprising”, “including”, and “having” are intended to be inclusive, indicate there may be other elements in addition to those listed elements.

As those skilled in the art could make various changes to the above constructions, products, and methods without departing from the intended scope of the description, all matter in the above description and accompanying drawings should be interpreted as illustrative and not in a limiting sense. The patentable scope of the disclosure is defined by claims when present, and can include other constructions and methods as would occur to those skilled in the art. Such other constructions are intended to be within the scope of the claims if the structural elements of the constructions do not differ from the literal language of the claims, or if the constructions include equivalent structural elements having insubstantial differences from the literal languages of the claims.

To the extent that the specification, including the claims and accompanying drawings, discloses additional subject matter that is not within the scope of the claims, the disclosures are not dedicated to the public and the right to file one or more applications having claims directed the additional disclosures is reserved.

1. A health monitoring system for monitoring health promoting conditions of a living space and health indications of an animal present in said living space, assessing the health promoting conditions to characterize healthfulness of the living space and the health indications to characterize health of the animal, and communicating the healthfulness and the health to a user in real time, said health monitoring system comprising:
a central control unit adapted for placement in the living space to regularly measure and record data indicative of the health promoting conditions in the living space including (i) temperature in the living space, (ii) humidity in the living space, and (iii) electrical power supplied to the living space;
wherein said central control unit is further adapted to:
receive sensor data transmitted by a sensing device selected from the group consisting of a living space sensor spaced from the central control unit for sensing a health promoting condition of the living space and an animal sensor positioned for measuring the health indication of the animal;
store said sensor data;
alert the user of an aberrant temperature condition if said temperature in the living space is outside a temperature limit;
alert the user of an aberrant humidity condition if said humidity in the living space is outside a humidity limit; and
alert the user of an electrical status change condition if the electrical power supplied to the living space changes by an amount exceeding a preselected power change limit.

2. A health monitoring system as set forth in claim 1 wherein said central control unit is further adapted to:
alert the user of a low temperature condition if said temperature in the living space is less than a low temperature limit;
alert the user of a high temperature condition if said temperature in the living space is greater than a high temperature limit;
alert the user of a low humidity condition if said humidity in the living space is less than a low humidity limit; and
alert the user of a high humidity condition if said humidity in the living space is greater than a high humidity limit.

3. A health monitoring system as set forth in claim 2 wherein said central control unit is further adapted to alert the user of the low temperature condition using at least one electronic transmission type selected from a group of electronic transmission types consisting of short message service and email, alert the user of the high temperature condition using at least one electronic transmission type selected from a group of electronic transmission types consisting of short message service and email, alert the user of the low humidity condition using at least one electronic transmission type selected from a group of electronic transmission types consisting of short message service and email, and alert the user of the high humidity condition using at least one electronic transmission type selected from a group of electronic transmission types consisting of short message service and email.

4. A health monitoring system as set forth in claim 2 wherein said central control unit is further adapted to alert the user of the low temperature condition by transmitting a signal to a mobile device, alert the user of the high temperature condition by transmitting a signal to a mobile device, alert the user of the low humidity condition by transmitting a signal to a mobile device, and alert the user of the high humidity condition by transmitting a signal to a mobile device.

5. A health monitoring system as set forth in claim 1 wherein said central control unit further comprises a user interface for inputting a temperature limit and a humidity limit.

6. A health monitoring system as set forth in claim 5 wherein said temperature limit comprises a low temperature limit and a high temperature limit, and said humidity limit comprises a low humidity limit and a high humidity limit.

7. A health monitoring system as set forth in claim 5 wherein said user interface is adapted to display temperature data, humidity data, time, and sensor data.

8. A health monitoring system as set forth in claim 1 wherein said central control unit is further adapted to:
calculate heat index from said temperature and said humidity; and
alert the user of a high heat index condition if said heat index is greater than a high heat index limit.

9. A health monitoring system as set forth in claim 1 wherein said central control unit is further adapted to:
measure and record at a preselected interval air quality index (AQI) data, total volatile organic compound (TVOC) data, and carbon dioxide data within the living space;
alert the user of a high AQI condition if said AQI data is greater than a high AQI limit;
alert the user of a high TVOC condition if said TVOC data is greater than a high TVOC limit; and
alert the user of a high carbon dioxide condition if said carbon dioxide data is greater than a high carbon dioxide limit.

10. A health monitoring system as set forth in claim 9 wherein said preselected interval is less than about ten minutes.

11. A health monitoring system as set forth in claim 1 wherein said sensing device and said central control unit are adapted to communicate with one another and with other devices, vehicles, appliances, and other objects via an Internet of Things (IoT) network.

12. A health monitoring system as set forth in claim 1 wherein said central control unit is further adapted to:
receive global positioning system (GPS) data from a GPS sensor;
provide the GPS data to the user; and
alert the user if the GPS sensor crosses a geofence.

13. A health monitoring system as set forth in claim 1 further comprising at least one sensing device selected from a group consisting of a living space door position sensor, a living space water level sensor, a living space water leak sensor, a living space slope sensor, an animal diagnostic characteristic sensor, and an animal smart bowl.

14. A health monitoring system as set forth in claim 13 wherein the sensing device includes an animal diagnostic characteristic sensor mounted in an animal bed adapted to measure at least one characteristic of a group consisting of animal weight, animal body temperature, animal heart rate, and animal respiration rate.

15. A health monitoring system as set forth in claim 13 wherein the animal diagnostic characteristic sensor measures at least one characteristic selected from a group consisting of animal body temperature, animal heart rate, blood oxygen saturation of the animal, blood pressure of the animal, animal movement, animal activity level, animal sleep duration, animal location, animal destructiveness, animal wellness, animal comfort, animal connectedness, and animal bondedness.

16. A health monitoring system as set forth in claim 13 wherein the animal smart bowl measures at least one characteristic selected from a group consisting of food consumption, calories consumed, food quantity, calories available, and presence of the animal.

17. A health monitoring system as set forth in claim 13 wherein the animal diagnostic characteristic sensor is adapted to be secured to the animal.

18. A health monitoring system for monitoring health promoting conditions of a living space and health indications of an animal present in said living space, assessing the health promoting conditions to characterize healthfulness of the living space and the health indications to characterize health of the animal, and communicating the healthfulness and the health to a user in real time, said health monitoring system comprising:
a central control unit adapted for placement in the living space to regularly measure and record data indicative of the health promoting conditions in the living space including (i) temperature in the living space and (iii) electrical power supplied to the living space;
wherein said central control unit is further adapted to:
receive sensor data transmitted by a sensing device selected from the group consisting of a living space sensor spaced from the central control unit for sensing a health promoting condition of the living space and an animal sensor positioned for measuring the health indication of the animal;
store said sensor data;
alert the user of an aberrant temperature condition if said temperature in the living space is outside a temperature limit by transmitting a signal to a mobile device; and
alert the user of an electrical status change condition if the electrical power supplied to the living space changes by an amount exceeding a preselected power change limit by transmitting a signal to a mobile device.

19. A health monitoring system as set forth in claim 18 further comprising at least one sensing device selected from a group consisting of a living space door position sensor, a living space water level sensor, a living space water leak sensor, a living space slope sensor, an animal diagnostic characteristic sensor, and an animal smart bowl.

20. A method for using a central control unit adapted for placement in a living space for monitoring health promoting conditions of a living space and health indications of an animal present in said living space and assessing the health promoting conditions to characterize healthfulness of the living space and the health indications to characterize health of the animal, and communicating the healthfulness and the health to a user in real time, said method comprising:
measuring and recording data with the central control unit in the living space, said data indicative of the health promoting conditions in the living space including (i) temperature in the living space, (ii) humidity in the living space, and (iii) electrical power supplied to the living space;
receiving sensor data with the central control unit transmitted by a sensing device selected from the group consisting of a living space sensor spaced from the central control unit for sensing a health promoting condition of the living space and an animal sensor positioned for measuring the health indication of the animal;
storing said sensor data;
alerting the user of an aberrant temperature condition if said temperature in the living space is outside a temperature limit;
alerting the user of an aberrant humidity condition if said humidity in the living space is outside a humidity limit; and
alerting the user of an electrical status change condition if the electrical power supplied to the living space changes by an amount exceeding a preselected power change limit.
